(19) United States
(12) Patent Application Publication
(10) Pub. No.: US 2023/0112049 A1
(43) Pub. Date: Apr. 13, 2023

(54) COMMUNICATION METHOD AND APPARATUS FOR OPEN RADIO ACCESS NETWORK (O-RAN)

(71) Applicant: SAMSUNG ELECTRONICS CO., LTD., Suwon-si (KR)

(72) Inventors: Yuhan HU, Beijing (CN); Ye HE, Beijing (CN); Deming XIU, Beijing (CN); Haoqiu SHE, Beijing (CN); Ming JIN, Beijing (CN)

(21) Appl. No.: 17/977,356

(22) Filed: Oct. 31, 2022

Related U.S. Application Data
(63) Continuation of application No. PCT/KR2022/014700, filed on Sep. 29, 2022.

(30) Foreign Application Priority Data
Sep. 30, 2021 (CN) 202111158924.0

(51) Int. Cl. H04W 28/02; H04W 28/18; H04W 8/24

(52) U.S. Cl. CPC H04W 28/0268; H04W 28/18; H04W 8/24

(57) ABSTRACT

Embodiments of the disclosure provide a communication method and apparatus for an open radio access network (O-RAN), an electronic device, and a computer-readable storage medium, relating to communication. The method comprises: determining, by an O-RAN distributed unit (O-DU), for a periodic or semi-persistent channel or signal, that that a trigger condition for a first control-plane message is satisfied; and transmitting, by the O-DU, a first control-plane message to an O-RAN radio unit (O-RU), the first control-plane message indicating a first endpoint in the O-RU to perform an operation related to first information, the O-RU configured to periodically control receiving uplink air interface data or processing downlink user-plane messages based on the first information. In various embodiments of the disclosure, periodically transmitting control-plane messages is avoided and the message load of the fronthaul interface is thus effectively reduced. Therefore, for channels or signals with periodic or semi-persistent characteristics, a defect that loads of the fronthaul interface could not be reduced by the existing solutions can be addressed.

### CROSS-REFERENCE TO RELATED APPLICATIONS

This application is a continuation of International Application No. PCT/KR2022/014700 designating the United States, filed on Sep. 29, 2022, in the Korean Intellectual Property Receiving Office and claiming priority to Chinese Patent Application No. 202111158924.0, filed on Sep. 30, 2021, in the Chinese Patent Office, the disclosures of which are incorporated by reference herein in their entireties.

### BACKGROUND

### Field

The disclosure relates to a communication method and apparatus, and for example, to a communication method and apparatus for an open radio access network (O-RAN).

### Description of Related Art

In a closed base station system, a fronthaul interface (FH I/F) between the Distributed Unit (DU) and the Radio Unit (RU) is usually a one-to-one dedicated interface which is directly connected via an optical fiber or coaxial cable. Therefore, how to reduce the load of the fronthaul interface is not a problem that needs to be focused on. However, in the O-RAN, the Open FH I/F between the O-RAN Distributed Unit (O-DU) and the O-RAN Radio Unit (O-RU) may be a network, and there may be a plurality of switches on the network. Therefore, in order to meet strict latency requirements on a shared link with limited bandwidth, extensive researches and discussions have been made to reduce the load of the fronthaul interface. Various methods have been used in the prior art to reduce the load of the fronthaul interface. For example, the downlink transmission and uplink reception of air interface data is controlled by means of real-time control of control-plane messages or static configuration of management-plane messages in order to reduce the load of the fronthaul interface.

However, in new radio (NR) and long term evolution (LTE), various channels or signals have periodic or semi-persistent characteristics. If the transmission or reception of these channels or signals is controlled by means of real-time control of control-plane messages, control-plane messages carrying the same scheduling information need to be transmitted from the O-DU to the O-RU in each period, which increases the control-plane message load of the fronthaul interface. If the transmission or reception of these channels or signals is controlled by means of static configuration of management-plane messages, only control-plane messages for physical random access channels (PRACHs) and sounding reference signals (SRSs), which are transmitted from the O-DU to the O-RU, can be reduced, and this control method has great limitations and defects, for example, the carrier cannot be modified after it is activated and the fronthaul interface resources from the O-RU to the O-DU are wasted.

### SUMMARY

Embodiments of the disclosure provide a communication method and apparatus for an open radio access network (O-RAN), an electronic device, and a computer-readable storage medium, by which, for channels or signals with periodic or semi-persistent characteristics, a defect that loads of the fronthaul interface could not be reduced by the existing solutions can be addressed.

According to an example embodiment, a communication method for an open radio access network (O-RAN), applied to an O-RAN distributed unit (O-DU) is provided, comprising: for a periodic or semi-persistent channel or signal, determining that a trigger condition for a first control-plane message is satisfied; and transmitting a first control-plane message to an O-RAN radio unit (O-RU), the first control-plane message indicating a first endpoint in the O-RU to perform an operation related to first information, the O-RU configured to periodically control receiving uplink air interface data or processing downlink user-plane messages based on the first information.

According to an example embodiment, provided is a communication method for an open radio access network (O-RAN), applied to an O-RAN radio unit (O-RU), comprising: receiving a first control-plane message from an O-DU, the first control-plane message indicating a first endpoint in the O-RU to perform an operation related to first information; and performing the operation related to the first information in a first endpoint, according to the first control-plane message, wherein the O-RU is configured to periodically control receiving uplink air interface data or processing downlink user-plane messages based on the first information.

According to an example embodiment, provided is a communication apparatus for an open radio access network (O-RAN), applied to an O-RAN distributed unit (O-DU), comprising: a determination module comprising circuitry configured to determine, for a periodic or semi-persistent channel or signal, that a trigger condition for a first control-plane message is satisfied; and a transmitting module comprising circuitry configured to transmit a first control-plane message to an O-RAN radio unit (O-RU), the first control-plane message indicating a first endpoint in the O-RU to perform an operation related to first information, wherein the O-RU is configured to periodically control receiving uplink air interface data or processing downlink user-plane messages based on the first information.

According to an example embodiment, provided is a communication apparatus for an open radio access network (O-RAN), applied to an O-RAN radio unit (O-RU), comprising: a receiving module comprising circuitry configured to receive a first control-plane message from an O-DU, the first control-plane message indicating a first endpoint in the O-RU to perform an operation related to first information; and a processing module comprising a processor configured to: perform the operation related to the first information in a first endpoint, according to the first control-plane message, wherein the O-RU is configured to periodically control receiving uplink air interface data or processing downlink user-plane messages based on the first information.

According to an example embodiment, provided is an electronic device, comprising: a processor; and a memory storing machine-readable instructions that, when executed by the processor, cause the processor to perform operations of various methods according to various embodiments. The electronic device may include an O-RAN distributed unit (O-DU), and the processor may, when running the computer programs, execute operations corresponding to the communication method performed by the O-DU in any embodiment of the present disclosure. The electronic device may include an O-RAN radio unit (O-RU), and the processor may, when running the computer programs, execute operations corresponding to the communication method performed by the O-RU in any embodiment of the present disclosure.

According to an example embodiment, provided is a non-transitory computer-readable storage medium having computer programs stored thereon that, when executed by a processor, cause an electronic device to perform operations of the communication method for an open radio access network (O-RAN) according to various embodiments of the present disclosure.

According to various embodiments, a method performed by an open radio access network (O-RAN) distributed unit (O-DU), the method comprises, for a periodic or semi-persistent signaling, determining that a trigger condition for a first control-plane message is satisfied; and transmitting the first control-plane message to an O-RAN radio unit (O-RU), the first control-plane message indicating a first endpoint in the O-RU and being associated with first information. The first information is used to periodically control to receive uplink air interface data or process downlink user-plane messages in the O-RU.

According to various embodiments, a method performed by an open radio access network (O-RAN) radio unit (O-RU), the method comprises receiving a first control-plane message from an O-DU, the first control-plane message indicating a first endpoint in the O-RU RU and being associated with first information, and performing an operation related to the first information in the first endpoint, based on the first control-plane message. The first control-plane message is associated with a periodic or semi-persistent signaling. The first information is used to periodically control to receive uplink air interface data or process downlink user-plane messages in the O-RU.

According to various embodiments, an apparatus of an open radio access network (O-RAN) distributed unit (O-DU), comprises at least one transceiver; and at least one processor operably coupled to the at least one transceiver. The at least one processor is configured to, for a periodic or semi-persistent signaling, determine that a trigger condition for a first control-plane message is satisfied; and transmit the first control-plane message to an O-RAN radio unit (O-RU), the first control-plane message indicating a first endpoint in the O-RU and being associated with first information. The first information is used to periodically control to receive uplink air interface data or process downlink user-plane messages in the O-RU.

According to various embodiments, an apparatus of an open radio access network (O-RAN) radio unit (O-RU), comprises at least one transceiver; and at least one processor operably coupled to the at least one transceiver. The at least one processor is configured to, receive a first control-plane message from an O-DU, the first control-plane message indicating a first endpoint in the O-RU and being associated with first information; and perform an operation related to the first information in the first endpoint, based on the first control-plane message. The first control-plane message is associated with a periodic or semi-persistent signaling. The first information is used to periodically control to receive uplink air interface data or process downlink user-plane messages in the O-RU.

By determining, for a periodic or semi-persistent channel or signal, that a trigger condition for a first control-plane message is satisfied; and transmitting a first control-plane message to an O-RAN radio unit (O-RU), the first control-plane message indicating a first endpoint in the O-RU to perform an operation related to first information, the O-RU configured to periodically control receiving uplink air interface data or processing downlink user-plane messages, the periodic transmission of control-plane messages is avoided and the message load of the fronthaul interface is thus effectively reduced. Therefore, for channels or signals with periodic or semi-persistent characteristics, a defect that loads of the fronthaul interface could not be reduced by the existing solutions can be overcome.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example configuration of the gNB/eNB reference architecture in an O-RAN;

FIG. 2A is a flowchart illustrating an example method of real-time control of transmitting air interface data by control-plane messages according to various embodiments;

FIG. 2B is a flowchart illustrating an example method of real-time control of receiving air interface data by control-plane messages according to various embodiments;

FIG. 3 is a diagram illustrating an example structure of a control-plane message according to various embodiments;

FIG. 4 is a flowchart illustrating an example method for static configuration of management-plane messages according to various embodiments;

FIG. 5 is a flowchart illustrating an example communication method for an open radio access network (O-RAN) according to various embodiments;

FIG. 6 is a flowchart illustrating an example communication method for an open radio access network (O-RAN) according to various embodiments;

FIG. 7 is a flowchart illustrating an example communication method for an open radio access network (O-RAN) according to various embodiments;

FIG. 8 is a flowchart illustrating an example communication method for an open radio access network (O-RAN) according to various embodiments; and

FIG. 9 is a block diagram illustrating an example configuration of an electronic device according to various embodiments.

### DETAILED DESCRIPTION

Embodiments of the present disclosure will be described in greater detail below. The various example embodiments have been illustrated in the drawings throughout which same or similar reference numerals refer to same or similar elements or elements having same or similar functions. The various example embodiments are described with reference to the drawings and are illustrative, merely used for explaining the present disclosure and should not be regarded as any limitations thereto.

It should be understood that singular forms “a”, “an”, “the”, and “said” may be intended to include plural forms as well, unless otherwise stated. It should be further understood that terms “include/including” used in this disclosure specify the presence of the stated features, integers, steps, operations, elements and/or components, but not exclusive of the presence or addition of one or more other features, integers, steps, operations, elements, components, and/or combinations thereof. It should be understood that when a component is referred to as being “connected to” or “coupled to” another component, it may be directly connected or coupled to other elements or provided with intervening elements therebetween. In addition, “connected to” or “coupled to” as used herein may include wireless connection or coupling. As used herein, term “and/or” includes all or any of one or more associated listed items or combinations thereof.

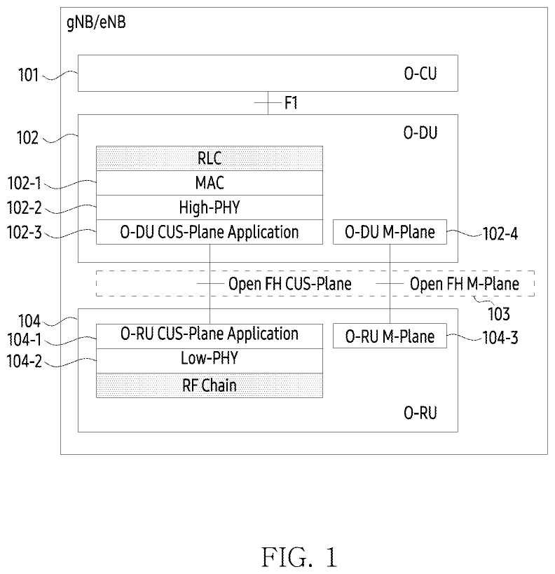

FIGS. 1-9, to be discussed below, and various embodiments used to describe the present disclosure are illustrative and should not be construed in any way to limit the scope of the present disclosure. It should be understood by one skilled in the art that the principles of the present disclosure may be implemented in any suitably arranged system or device.

The base station reference architecture in an O-RAN is shown in FIG. 1. The base station in the drawing may be a next generation NodeB (gNB) supporting the 5G New Radio (NR) standard, or it may be a 4G Long Term Evolution (LTE) evolved NodeB (eNB). The reference architectures of gNB and eNB are slightly different, but may have no impact on the content of the present disclosure, so gNB and eNB will not be distinguished here. Functional entities other than the base station in an O-RAN and the interfaces between them and the base station will not be involved in the present disclosure, and therefore will not be shown in the drawing. The entities in the gray background in FIG. 1 are not directly related to the content of the present disclosure, so they will not be introduced here.

O-RAN Central Unit (O-CU) 101: contains logical nodes for the O-RAN Central Unit Control Plane (O-CU-CP) and the O-RAN Central Unit User Plane (O-CU-CP), wherein the O-CU-CP is a logical node that contains Radio Resource Control (RRC) and PDCP Packet Data Convergence Protocol (PDCP) control planes, and the O-CU-UP is a logical node that contains the PDCP user-plane and Service Data Adaptation Protocol (SDAP).

O-RAN Distributed Unit (O-DU) 102: contains Radio Link Control (RLC), Media Access Control (MAC), High Physical layer (High-PHY) and logical nodes with specific functions in an O-RAN.

MAC: 3GPP functional layer 102-1, responsible for multiplexing MAC SDUs (Service Data Units) from one or more different logical channels into Transport Blocks (TBs) and transmitting the TBs to the physical layer by the transport channels; and de-multiplexing the TBs delivered from the transport channels from the physical layer into MAC SDUs for one or more different logical channels; and other functions, such as, error correction by Hybrid Automatic Repeat reQuest (HARQ). It may also be a logical functional entity on the gNB/eNB, called scheduler, which dynamically allocates time and frequency resources of uplink and downlink air interfaces.

High-PHY 102-2: processing in the O-DU after the physical layer of the 3GPP functional layer is split, responsible for functions such as encoding/decoding, channel estimation, modulation/demodulation, and scrambling/descrambling.

O-DU CUS-Plane Application (O-DU Control, User, Synchronization-plane Application 102-3, referred to as O-DU application in the present disclosure): O-DU logical function, responsible for, via the fronthaul interface, creating Control-Plane (C-plane), User-Plane (U-plane) and Synchronization-Plane (S-Plane) messages and transmitting them to the O-RAN Radio Unit (O-RU), or receiving them from the O-RU and processing them. Wherein, the control-plane message bears the relevant information for controlling the user-plane message (such as scheduling and beamforming indication), and the user-plane message bears the time-frequency domain In-phase/Quadrature (I/Q) data, and the synchronization-plane message is used to realize the time-frequency synchronization between the O-DU and the O-RU.

O-DU Management Plane (M-Plane) 102-4: O-DU logical function, responsible for initialization of the O-RU based on Network Configuration/Yet Another Next Generation (NETCONF/YANG), software management, configuration management, performance management, fault management, file management, etc.

O-RAN Open Fronthaul interface (OFH I/F) 103: including CUS-Plane and M-Plane interfaces, which are interfaces based on enhanced Common Public Radio Interface (eCPRI) or Institute of Electrical and Electronics Engineers (IEEE).

O-RAN Radio Unit (O-RU) 104: gNB/eNB physical nodes in an O-RAN, containing Low Physical layer (Low-PHY) and radio frequency chain (RF Chain).

O-RU CUS-Plane Application (O-RU Control, User, Synchronization-plane Application, referred to as O-RU application in the present disclosure) 104-1: O-RU logical function, responsible for, via the fronthaul interface, creating C-Plane, U-Plane and S-Plane messages and transmitting them to the O-DU, or receiving them from the O-DU and processing them.

Low-PHY 104-2: processing in the O-RU after the physical layer of the 3GPP functional layer is split, responsible for functions such as FFT/iFFT (Fast Fourier Transformation /Invert Fast Fourier Transformation), analog beamforming, digital beamforming, digital-to-analog/analog-to-digital conversion.

O-RU M-Plane 104-3: O-RU logical function, managed by the O-DU M-Plane, informing the O-DU of optional capabilities supported by the O-RU by capability reporting to the O-DU in the initialization phase.

There may be two ways to control the downlink transmission and uplink reception of air interface data:

1. real-time control of control-plane messages; and

2. static configuration of management-plane messages.

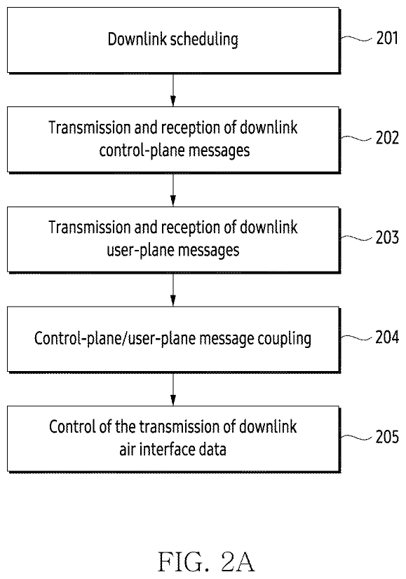

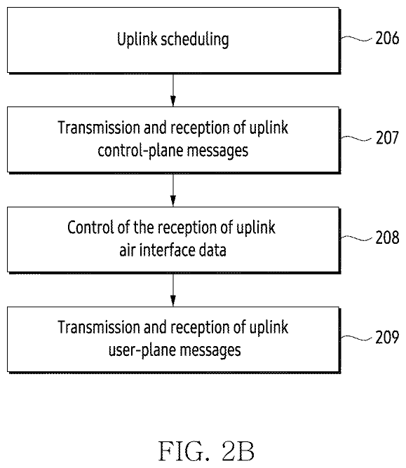

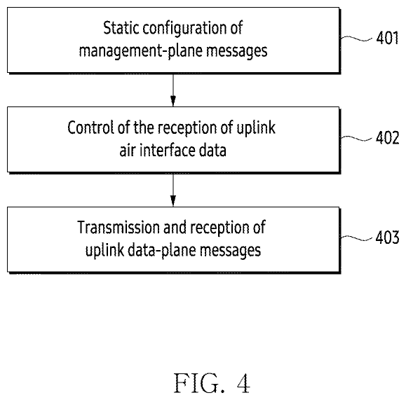

The processing flows in these two ways are shown in FIGS. 2A, 2B and FIG. 4, respectively.

FIGS. 2A and 2B are flowchart illustrating examples of the processing flow for control-plane messages, which has different processing ways for uplink and downlink according to various embodiments.

FIG. 2A illustrates an example of the downlink transmission flow.

Operation 201 is downlink scheduling, which is performed in the O-DU, and may be performed, for example, in the 102-1 MAC scheduler. After the MAC scheduler completes the downlink scheduling, on one hand, it transmits the downlink scheduling result to the High-PHY for processing such as modulation and encoding, and simultaneously, it also transmits the downlink scheduling result to the O-DU application for the creation of control-plane messages and user-plane messages. The minimum time granularity of the downlink scheduling result is Orthogonal Frequency Division Multiplexing (OFDM) symbol (referred to as symbol for short), and the minimum frequency granularity of the downlink scheduling result is Resource Element (RE), which occupies one symbol in the time domain and one subcarrier in the frequency domain). The scheduling result includes, but is not limited to, beam identifiers, and time-domain and frequency-domain resource allocation information of Physical Downlink Shared Channels (PDSCHs), Physical Downlink Control Channels (PDCCHs), Channel State Information - Reference Signals (CSI-RSs), and the like.

Operation 202 is the transmission and reception of downlink control-plane messages, which may be performed, for example, in the O-DU and O-RU, for example in the 102-3 O-DU application, 103 FH I/F, and 104-1 O-RU application. The O-DU application creates, according to the scheduling result, a control-plane message for controlling how to transmit data via the downlink air interface, and transmits the control-plane message to the O-RU application through the FH I/F. The control-plane message mainly indicates the symbol, Physical Resource Block (PRB), RE and beam identifier, iFFT parameters and other information. The O-RU application receives the control-plane message and obtains various fields of the transport layer and the application layer from the control-plane message.

Operation 203 is the transmission and reception of downlink user-plane messages, which may be performed, for example, in the O-DU and O-RU, for example in the 102-3 O-DU application, 103 FH I/F, and 104-1 O-RU application. The O-DU application creates the modulated and encoded I/Q data output by the High-PHY as a downlink user-plane messages, and transmits it to the O-RU application through the FH I/F. The user-plane message mainly carries I/Q data carried on each RE in the designated symbols and the PRBs. The O-RU application receives the user-plane message and obtains various fields of the transport layer and the application layer and the I/Q data from the user-plane message.

Operation 204 is the control-plane/user-plane message coupling, which is performed in the O-RU, and may be performed, for example, in the 104-1 O-RU application. Since the control-plane message and the user-plane message are transmitted separately, it is necessary to couple the section description in the control-plane information and the data section in the user-plane message. The basic coupling method is coupling based on the section identifier (sectionId). In addition, in order to reduce the number of section descriptions in the control-plane message, coupling methods such as coupling based on time-frequency resources and coupling based on time-frequency resources with priority are disclosed.

Operation 205 is the control of transmitting downlink air interface data, which is performed in the O-RU, and may be performed, for example, in the 104-1 O-RU application and 104-2 Low-PHY. After the O-RU application completes the coupling, it submits the coupled section description and data section to the Low-PHY; and the Low-PHY processes the coupled section description and data section, and performs digital beamforming, IFFT (fast Fourier transform), analog beamforming and other processing on downlink data sections according to the control information indicated in the section description.

FIG. 2B illustrates an example of the upstream reception flow.

Operation 206 is uplink scheduling, which may be performed, for example, in the O-DU, and for example, may be performed in the 102-1 MAC scheduler. After the MAC scheduler completes the uplink scheduling, on one hand, it transmits the uplink scheduling result to the High-PHY for decoding and demodulation of the user-plane data after receiving the user-plane data from the O-RU, and it also transmits the uplink scheduling result to the O-DU application for creation of a control-plane message. The minimum time granularity of the uplink scheduling result is symbol, and the minimum frequency granularity is RE. The scheduling result includes, but is not limited to, beam identifiers, and time-domain and frequency-domain resource allocation information of Physical Uplink Shared Channels (PUSCHs), (Physical Uplink Control Channels (PUCCHs), Sounding Reference Signals (SRSs), Physical Random Access Channels (PRACHs), and the like.

Operation 207 is the transmission and reception of uplink control-plane messages, which may be performed, for example, in the O-DU and O-RU, for example, in the 102-3 O-DU application, 103 FH I/F, and 104-1 O-RU application. The O-DU application creates, according to the scheduling result, a control-plane message for controlling how to receive data via the uplink air interface, and transmits the control-plane message to the O-RU application through the FH I/F. The control-plane message mainly indicates the symbol, PRB, RE and beam identifier, FFT parameters and other information. The O-RU application receives the control-plane message and obtains various fields of the transport layer and the application layer from the control-plane message.

Operation 208 is the control of receiving uplink air interface data, which may be performed, for example in the O-RU, and for example may be performed in the 104-1 O-RU application and 104-2 Low-PHY. The O-RU application indicates to the High-PHY the control information carried in the section description in the control-plane message. High-PHY performs analog beamforming, FFT, digital beamforming and other processing on the uplink air interface data according to the control information, and then submits the processed I/Q data to the O-RU application.

Operation 209 is the transmission and reception of uplink user-plane messages, which may be performed, for example, in the O-DU and O-RU, for example in the 104-1 O-RU application, 103 FH I/F, and 102-3 O-DU application. The O-RU application creates the I/Q data submitted by the Low-PHY as an uplink user-plane message, and transmits it to the O-DU application through the FH I/F. The user-plane message mainly carries I/Q data carried on each RE in the designated symbols and the PRBs. The O-DU application receives the user-plane message, obtains I/Q data carried on each RE in the designated symbols and the PRBs from the user-plane message, and then submits the I/Q data to the High-PHY for subsequent decoding and demodulation and so on.

Each control-plane message in FIG. 2 belongs to a certain endpoint (called low-level-tx-endpoint and low-level-rx-endpoint, referred to as endpoint for short, the endpoint may be a receiving endpoint corresponding to the uplink or a transmitting endpoint corresponding to the downlink). Each endpoint is assigned a unique extended antenna-carrier identifier (abbreviated as eAxC Id). The identifier is carried in the transport layer header of the control-plane message and the user-plane message, and is used by the O-RU and O-DU to distinguish which endpoint the message belongs to.

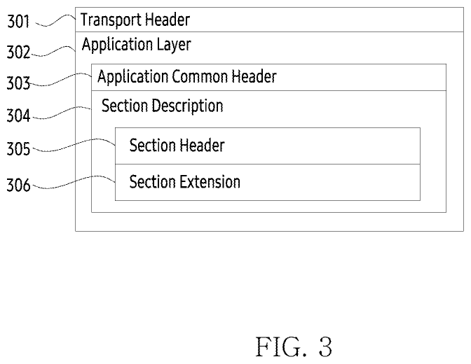

The structure of the transport layer in the control-plane message is illustrated, for example, in FIG. 3.

Transport Header 301: it may be an enhanced public radio interface (eCPRI) header and a radio over Ethernet (ROE) header, containing information such as eAxC Id.

Application Layer 302: the payload of the transport layer.

Application Common Header 303: contains data direction (dataDirection), frame identifier (frameId), subframe identifier (subframeId), slot identifier (slotID), start symbol identifier (startSymbolid), the number of sections (numberOfsections) and other information.

Section Description 304: contains information used to control the transmission or reception of user-plane messages. One control-plane message may contain a plurality of section descriptions.

Section Header 305: contains a section identifier (sectionID), a symbol increment flag (symInc), the number of symbols (numSymbol), and frequency-domain resource information (PRB information, RE information), a beam identifer (beamId), an extension flag (ef) and other information.

Section Extension 306: contains additional description of the control information contained in the section header. One section description may contain a plurality of section extensions, which are indicated by the extension flag (ef).

FIG. 4 is a flowchart illustrating an example method of static configuration of management-plane messages according to various embodiments. This example does not need to control receiving uplink air interface data through control-plane messages, and this solution is valid only for PRACHs and SRSs.

Operation 401 is the static configuration of management-plane messages, which may, for example, be performed in the O-DU and O-RU, and may, for example, be performed in the 102-4 O-DU management plane, 103 FH I/F, and 104-3 O-RU management plane. The O-DU management plane creates the PRACH or SRS start time, period, time-frequency domain resource location, beam identifier and other information into a management-plane message, and transmits the management-plane message to the O-RU management plane through the FH I/F. The O-RU management plane receives the management-plane message and obtains static configuration information from the management-plane message. For each static configuration, the operation 401 is performed only once before the carrier is activated. If the configuration needs to be modified, it is necessary to deactivate the carrier, the O-DU or the O-RU may modify the configuration, and the O-DU or the O-RU may reactivate the carrier.

Operation 402 is the control of receiving uplink air interface data, which may, for example, be performed in the O-RU, and may, for example, be performed in the 104-3 O-RU management plane and 104-2 Low-PHY. If the current symbol instant (indicated by frame identifier, subframe identifier, slot identifier, and symbol identifier) matches the symbol instant calculated from the start time and period indicated in a certain static configuration, the O-RU management plane indicates to the Low-PHY the control information in the static configuration. Low-PHY performs analog beamforming, FFT, digital beamforming and other processing on the uplink air interface data according to the control information, and then submits the processed I/Q data to the O-RU application.

Operation 403 may, for example, be performed in the O-RU and O-DU, and may, for example, be in the 104-1 O-RU application, 103 FH I/F, and 102-3 O-DU application. The O-RU application creates the I/Q data submitted by the Low-PHY as an uplink user-plane message, and transmits the uplink user-plane message to the O-DU application through the FH I/F. The O-DU application receives the user-plane message, obtains I/Q data carried on each RE in the designated symbols and the PRBs from the user-plane message, and then submits the I/Q data to the High-PHY for subsequent decoding and demodulation and so on.

In NR and LTE, various channels or signals have periodic or semi-persistent characteristics, including but not limited to: periodic/semi-persistent SRSs, PRACHs, periodic/semi-persistent CSI-RSs, CRSs, and Semi-Persistent Scheduling (SPS) PDSCH/PUSCHs, etc.

For a control of a transmission or reception of these channels or signals, if the processing flow with control-plane messages shown in FIG. 2 is adopted, the control-plane messages carrying the same scheduling information need to be transmitted from the O-DU to the O-RU in each period, which increases the control-plane message load of the fronthaul interface. However, if the processing flow for the static configuration of management-plane messages shown in FIG. 4 is adopted, only control-plane messages for PRACH and SRS, which are transmitted from the O-DU to the O-RU, can be reduced, and this method has great limitations and defects:

1. The carrier cannot be modified after it is activated.

2. The fronthaul interface resources from the O-RU to the O-DU are wasted.

Reasons for these defects include that the static configuration of the management plane cannot be changed after the carrier is activated. All the combinations may be configured according to the period, time-frequency domain location, beam identifier and other information of all possible PRACH/SRSs, only before the carrier is activated. However, this will involve the reception of a large number of unallocated channels or signals, resulting in great increase in invalid user-plane messages transmitted from the O-RU to the O-DU on the fronthaul interface. If it is needed to modify the static configuration of the control plane according to the actual situation of channel or signal allocation, it is necessary to deactivate the carrier, the O-DU or O-RU may modify the configuration and then the O-DU or O-RU may reactivate the carrier, which will cause the UE that has accessed this carrier to drop and affect the user experience.

In addition, for SRSs, time-frequency domain resources and beam identifiers are directly related to the UE. They cannot be determined until the UE accesses the gNB/eNB and is allocated SRS resources, and may undergo unexpected changes after allocation (For example, the release of UE or the release of SRS resources, the change of the receiving beam because of UE movement, SRS resource reallocation caused by gNB/eNB SRS resource optimization algorithm, etc.). It is impossible to predict what beams will be used for the SRS reception on certain time-frequency domain resources, before the carrier is activated. Therefore, the solution of static configuration of management-plane messages is not suitable for SRSs.

Similarly, periodic/semi-persistent CSI-RSs and SPS PDSCH/PUSCHs are related to specific UEs and cannot be correctly configured in advance before carrier activation. Therefore, the load of the fronthaul interface cannot be reduced by the solution of static configuration of management-plane messages.

Accordingly, the present disclosure provides a communication method. By this method, based on the periodic/semi-persistent characteristics of some channels or signals (including but not limited to periodic/semi-persistent SRSs/CSI-RSs, PRACHs, CRSs, and SPS PDSCH/PUSCHs), the O-DU transmits a first control-plane message (the first control-plane message may be a control-plane message containing a first information section extension) to indicate to dynamically setup, modify or delete first information in an endpoint of the O-RU. The first information will be periodically reused by the O-RU to receive uplink air interface data or process downlink user-plane messages, avoiding periodic transmission of control-plane messages, thereby effectively reducing the message load of the fronthaul interface.

The first information may be referred to, for example, as reusable control information set (RCIS for short), or reusable control-plane information, or reusable section description.

The disclosure will be described in greater detail below with reference to various example embodiments. The various embodiments to be described below may be combined, and the same or similar concepts or processes may be not repeated in various embodiments. Various embodiments of the present disclosure will be described below with reference to the accompanying drawings. The text and drawings in the following description are provided as examples only to assist the readers in understanding the present disclosure. They are not intended and should not be construed to limit the scope of the present disclosure in any way. Although various embodiments and examples have been provided, it will be apparent to those skilled in the art based on the disclosure herein that the illustrated embodiments and examples can be modified without departing from the scope of the present disclosure.

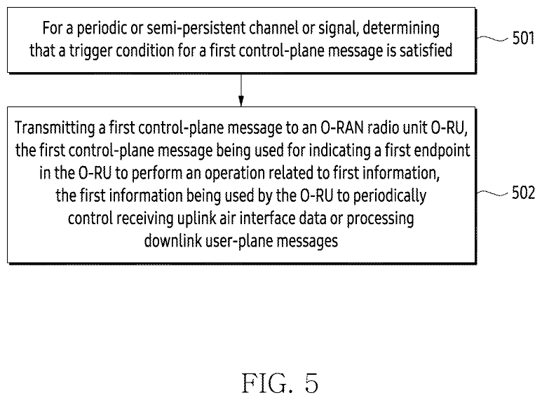

FIG. 5, is a flowchart illustrating an example communication method for an open radio access network (O-RAN), applied to an O-RAN distributed unit (O-DU), according to various embodiments.

In operation 501, the O-DU, for a periodic or semi-persistent channel or signal, determines that a trigger condition for a first control-plane message is satisfied.

In operation 502, the O-DU transmits a first control-plane message to an O-RAN radio unit (O-RU). The first control-plane message is used for indicating a first endpoint in the O-RU to perform an operation related to first information. The first information is used by the O-RU to periodically control receiving uplink air interface data or processing downlink user-plane messages.

In this example, by determining, for a periodic or semi-persistent channel or signal, that a trigger condition for a first control-plane message is satisfied; and transmitting a first control-plane message to an O-RAN radio unit (O-RU), the first control-plane message being used for indicating a first endpoint in the O-RU to perform an operation related to first information, the first information being used by the O-RU to periodically control receiving uplink air interface data or processing downlink user-plane messages, the periodic transmission of control-plane messages is avoided and the message load of the fronthaul interface is thus effectively reduced. Therefore, for channels or signals with periodic or semi-persistent characteristics, a defect that loads of the fronthaul interface could not be reduced by the existing solutions can be addressed.

In various embodiments, before operation 502, the method may further an operation of:

receiving information related to second endpoints, which is reported by the O-RU, the information related to the second endpoints including a first capability and a second capability possessed by the second endpoints, wherein the first capability indicates that the second endpoints support a first information section extension, and the second capability indicates a maximum value of a number of the first information supported by the second endpoints; and

determining, according to the information related to the second endpoints, the first endpoint from the second endpoints.

It should be noted that, in this example, other capabilities reported by the O-RU may also be received, wherein the capabilities related to the present disclosure include the maximum value of the number of section descriptions supported by the second endpoint in one symbol (max-sections-per-symbol) and the maximum value of the number of section descriptions supported by the second endpoint in one slot (max-sections-per-slot).

In an embodiment, the first endpoint may be an endpoint that satisfies a first condition from the second endpoints, and the first condition includes at least one of the following:

a total number of the pieces of the first information corresponding to the first endpoint does not exceed a maximum value indicated by the second capability of the first endpoint; and

a sum of a number of section descriptions that do not contain the first information section extension in one time unit and a number of pieces of the first information to be used in the one time unit does not exceed a maximum value of the number of section descriptions supported by the first endpoint in the one time unit.

For example, in the disclosure, the time unit may include at least one of OFDM symbols or slots.

For example, a sum of a number of section descriptions that do not contain the first information section extension in one symbol (the number of section descriptions in one existing symbol) and a number of pieces of the first information to be used in the symbol does not exceed a maximum value of the number of section descriptions supported by the first endpoint in one symbol. A sum of a number of section descriptions that do not contain the first information section extension in one slot (the number of section descriptions in one existing slot) and a number of pieces of the first information to be used in the slot does not exceed a maximum value of the number of section descriptions supported by the receiving endpoint in one slot.

In various embodiments, operation 501 may include, according to information related to a periodic or semi-persistent channel or signal, determining that a trigger condition for a first control-plane message is satisfied.

For example, in this example, the trigger condition for the first control-plane message may be determined according to whether the periodic or semi-persistent channel or signal is associated with existing first information in the O-RU.

If the periodic or semi-persistent channel or signal is not associated with existing first information in the O-RU, the first control-plane message may be triggered according to the maximum number of slots, and the period of the periodic or semi-persistent channel or signal to cause the O-RU to create first information. For example, if the period of the periodic/semi-persistent channel/signal is less than 2560*Nₛₗₒₜ slots, the first control-plane message is triggered to cause the O-RU to create new first information. Nₛₗₒₜ is the number of slots of the channel/signal in one subframe.

If the periodic/semi-persistent channel/signal is associated with existing first information in the O-RU, the first control-plane message is triggered to cause the O-RU to modify the first information. For example, when the UE moves to the coverage of another receiving beam from the coverage of a receiving beam, that is, the receiving beam of the UE is updated, and when the O-RU has configured first information for the UE before its movement, it is needed to modify the corresponding first information after the receiving beam of the UE changes.

If the periodic/semi-persistent channel/signal is associated with existing first information, and the first information is not associated with other periodic/semi-persistent channels/signals, the first control-plane message is triggered to cause the O-RU to delete the first information.

In various embodiments, before operation 502, the method may further include:

determining, according to the trigger condition, a type of the operation related to the first information; and

creating a first control-plane message, according to the type of the operation related to the first information and a period of the periodic or semi-persistent channel or signal.

For example, in this example, if the trigger condition is to create the first information, the operation related to the first information is determined as SETUP; if the trigger condition is to modify the first information, the operation related to the first information is determined as MODIFY; and if the trigger condition is to delete the first information, the operation related to the first information is determined as DELETE.

In an embodiment, the first control-plane message includes a first information section extension. Then, creating a first control-plane message may include determining a first information operation field, a first information identifier field and a first information period field in the first information section extension, according to the type of the operation related to the first information and the period of the periodic or semi-persistent channel or signal.

For example, in this example, according to the type of the operation related to the first information and the period of the periodic or semi-persistent channel or signal, the process of creating the first control-plane message is to determine the first information section extension included in the first control-plane message, specifically, to determine the first information operation field, the first information identifier field and the first information period field in the first information section extension.

If the first information is RCIS, then it is to determine the RCIS operation field, the RCIS index field and the RCIS period field in the RCIS section extension in the first control-plane message, wherein the RCIS operation field corresponds to the type of the operation related to the first information and is used to indicate the type of the operation on the first information, and different values indicate different operation types; the RCIS period field corresponds to a period of the periodic or semi-persistent channel or signal and is used to indicate the period in which the first information is reused for the user-plane message control; the RCIS index field is used to indicate that the first information is identified in the first endpoint, and is the unique index of the first information in the first endpoint.

In the foregoing examples, if the first control-plane message includes a plurality of first information section extensions, each first information section extension uses a different first information identifier.

In various embodiments, if the first endpoint is configured to be coupled by a section identifier, and when the first information is to be used in a current time unit, and a second control-plane message and the first information do not use different resource element (RE) masks to schedule the same physical resource blocks (PRBs), then a section identifier associated with the first information is not used for the second control-plane message in the current time unit.

For example, in this example, the second control-plane message is an existing control-plane message, and the current time unit is the current OFDM symbol.

In the various embodiments, the first control-plane message further includes: a section extension for indicating a section description of a group of extended antenna-carrier identifiers; and/or a section extension for indicating a priority of a section description.

For example, if the first control-plane message includes a section extension whose extension type is 10, it indicates that the first information will be applied to a group of endpoints. That is, one eAxCid is used to indicate the section description of a group of eAxCids, and then the first information will be applied to the endpoints corresponding to all eAxCids in the group.

In the various embodiments, if the first endpoint is a receiving endpoint, the periodic or semi-persistent channel or signal is a PRACH, or an SPS PUSCH, or a periodic or semi-persistent SRS; and

if the first endpoint is a transmitting endpoint, the periodic or semi-persistent channel or signal is an SPS PDSCH, or a CRS, or a periodic or semi-persistent CSI-RS.

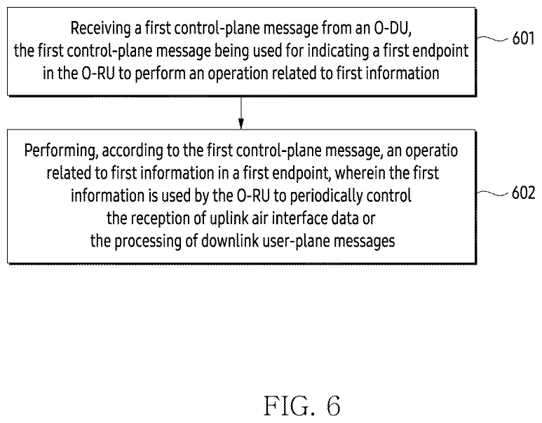

FIG. 6, is a flowchart illustrating an example communication method for an open radio access network (O-RAN), applied to an O-RAN radio unit (O-RU), according to various embodiments including:

Operation 601: receiving a first control-plane message from an O-DU, the first control-plane message being used for indicating a first endpoint in the O-RU to perform an operation related to first information; and

Operation 602: performing the operation related to the first information in a first endpoint, according to the first control-plane message, wherein the first information is used by the O-RU to periodically control receiving uplink air interface data or processing downlink user-plane messages.

In this example, by receiving a first control-plane message from an O-DU, the first control-plane message being used for indicating a first endpoint in the O-RU to perform an operation related to first information, and performing the operation related to the first information in a first endpoint, according to the first control-plane message, the first information being used by the O-RU to periodically control receiving uplink air interface data or processing downlink user-plane messages, the periodic transmission of control-plane messages is avoided and the message load of the fronthaul interface is thus effectively reduced. Therefore, for channels or signals with periodic or semi-persistent characteristics, a defect that loads of the fronthaul interface could not be reduced by the existing solutions can be addressed.

In various embodiments, before the operation 601, the method further includes reporting information related to second endpoints to an O-DU, the information related to second endpoints being used by the O-DU to determine the first endpoint.

The information related to second endpoints includes a first capability and a second capability possessed by the second endpoints, wherein the first capability indicates that the second endpoints support a first information section extension, and the second capability indicates a maximum value of a number of pieces of the first information supported by the second endpoints.

In this example, the first endpoint is an endpoint that satisfies a first condition from the second endpoints, and the first condition includes at least one of the following:

a total number of the pieces of the first information corresponding to the first endpoint does not exceed a maximum value indicated by the second capability of the first endpoint; and

a sum of a number of section descriptions that do not contain the first information section extension in one time unit and a number of pieces of the first information to be used in the one time unit does not exceed a maximum value of the number of section descriptions supported by the first endpoint in the one time unit.

In this example, the time unit may include at least one of OFDM symbols or slots.

For example, a sum of a number of section descriptions that do not contain the first information section extension in one symbol (the number of section descriptions in one existing symbol) and a number of pieces of the first information to be used in the symbol does not exceed a maximum value of the number of section descriptions supported by the first endpoint in one symbol. A sum of a number of section descriptions that do not contain the first information section extension in one slot (the number of section descriptions in one existing slot) and a number of pieces of the first information to be used in the slot does not exceed a maximum value of the number of section descriptions supported by the receiving endpoint in one slot.

In various embodiments, operation 602 may include determining a type of the operation related to the first information, according to the first control-plane message and performing the operation related to the first information in the first endpoint, according to the type of the operation related to the first information.

The example, the first control-plane message may include a first information section extension. The method may comprises determining the type of the operation related to the first information, according to a first information operation field in the first information section extension of the first control-plane message.

In this example, if the first information operation field in the first information section extension is SETUP, the operation related to the first information is determined as CREATE, that is, the operation related to the first information is to create first information; if the first information operation field in the first information section extension is MODIFY, the operation related to the first information is determined as MODIFY, that is, the operation related to the first information is to modify the first information; and if the first information operation field in the first information section extension is DELETE, the operation related to the first information is determined as DELETE, that is, the operation related to the first information is to delete the first information.

Various embodiments, the operation 602 may specifically include:

if the operation related to the first information is to setup the first information, and if no first information having a first information identifier equal to a first information identifier field in a first information section extension has been found in existing first information in the first endpoint, setting up first information including a first information identifier, a first information period, and first information section information, in the first endpoint;

if the operation related to the first information is to modify the first information, searching the first information having the first information identifier equal to the first information identifier field in the first information section extension from existing first information in the first endpoint, and modifying the found first information according to an application common header of the first control-plane message and a section description containing the first information section extension; and

if the operation related to the first information is to delete the first information, searching the first information having the first information identifier equal to the first information identifier field in the first information section extension from existing first information in the first endpoint, and deleting the found first information from existing first information in the first endpoint.

In this example, the first information section information included in the first information setup in the first endpoint is the application common header of the first control-plane message and section header, and the control information in the section description carrying the first information.

In an embodiment, if the first control-plane message further includes a section extension for indicating a group of extended antenna-carrier identifiers, operation 602 may include performing the operation related to the first information in endpoints corresponding to the group of extended antenna-carrier identifiers, according to the first control-plane message.

In the foregoing examples, if the first endpoint is a receiving endpoint, the method further includes:

For a given time unit, determining that one or more pieces of first information satisfying a second condition will be used for controlling receiving uplink air interface data, wherein the given time unit is a time unit in which the first control-plane message is received, or a time unit behind the time unit in which the first control-plane message is received.

In this example, if the receiving endpoint has one or more pieces of first information, for a given time unit, for example, a certain symbol (frameId=n′_{f}, subframeId=n′_{sf}, slotId=n′ₛₗₒₜ, symbolId=n′_{sym}), it is determined that one or more pieces of first information satisfying the second condition will be used for controlling receiving uplink air interface data, wherein the given time unit is a time unit in which the first control-plane message is received, or a time unit behind the time unit in which the first control-plane message is received.

The second condition includes:

mod (curSlot−rcisStartSlot+MAX_SLOT_N, rcisPeriod)=0, and

n′_{sym} is equal to the symbol identifier obtained using rcisSectionInfo in the first information according to the existing related method,

where curSlot is the current slot identifier, which is equal to (n′_{f}*10+n′_{sf})*Nₛₗₒₜ+n′ₛₗₒₜ, Nₛₗₒₜ is the number of slots in a subframe;

mod(x, y) represents the remainder obtained by dividing x by y;

rcisStartSlot and rcisPeriod are obtained from the first information; and

MAX_SLOT_N is equal to 2560*Nₛₗₒₜ.

It should be noted that the above solution is aimed at the situation where the second control-plane message and the first information that control the same resource element (RE) of the given time unit do not exist simultaneously.

In various embodiments, if the second control-plane message and the first information that control the same resource element (RE) of the given time unit exist simultaneously, the method further includes:

if the second control-plane message or the first information includes a section extension for indicating a priority of a section description, determining one with a higher priority from the first information and a first section description, and using the one with the higher priority to control receiving uplink air interface data, wherein the first section description is a section description with the highest priority in the second control-plane message; and

if neither the second control-plane message nor the first information includes the section extension for indicating the priority of the section description, determining that the second control-plane message or the first information will be used for controlling receiving uplink air interface data.

In this example, a section extension Type 6, 12, or 19 may be used to indicate the section extension of the priority of the section description.

If neither the second control-plane message nor the first information includes the section extension for indicating the priority of the section description, this is an undefined behavior. In this case, the O-RU is free to choose the second control-plane message or the first information for controlling receiving uplink air interface data.

In various embodiments, the method further includes:

if the determined first information is used for controlling receiving uplink air interface data, transmitting corresponding data to the O-DU through one or more uplink user-plane messages, wherein the application common header and the section header of the uplink user-plane messages are obtained according to the first information and information related to the given time unit.

If the given time unit is a symbol, the information related to the given time unit may include: frameId n′_{f}, subframeId n′_{sf}, slotId n′ₛₗₒₜ, and symbolId n′_{sym}.

For example, if it is determined in the step 603 that one or more pieces of first information satisfying the second condition will be used for controlling receiving uplink air interface data, the determined first information may be used for controlling receiving uplink air interface data, and the corresponding data may be transmitted to the O-DU through one or more uplink user-plane messages.

If the one with the higher priority, determined, is the first information, the determined first information may also be used for controlling receiving uplink air interface data, and the corresponding data may be transmitted to the O-DU through one or more uplink user-plane messages.

If the first information is selected for controlling receiving uplink air interface data, the first information is used for controlling receiving uplink air interface data, and the corresponding data is transmitted to the O-DU through one or more uplink user-plane messages.

In the foregoing examples, if the first endpoint is a transmitting endpoint, the method further includes:

if the transmitting endpoint has corresponding first information, for the received downlink user-plane messages, determining first information coupled with the downlink user-plane messages; and

using the first information coupled with the downlink user-plane messages to control processing the downlink user-plane messages.

In this example, if the transmitting endpoint has one or more pieces of first information, the first information coupled with the received downlink user-plane messages is used for controlling processing downlink user-plane messages.

It should be noted that the above solution the second control-plane message coupled with the received downlink user-plane messages does not exist in the same RE in the same time unit.

In various embodiments, if the second control-plane message and the first information coupled with the downlink user-plane messages exist simultaneously in the same RE in the same time unit, the method further includes:

If the second control-plane message or the first information includes a section extension for indicating a priority of a section description, determining one with a higher priority from the first information and a second section description, and using the one with the higher priority to control processing downlink user-plane messages, wherein the second section description is a section description with the highest priority in the second control-plane message; and

If neither the second control-plane message nor the first information includes the section extension for indicating the priority of the section description, determining that the second control-plane message or the first information will be used for controlling processing downlink user-plane messages.

For example, the above solution is aimed at the situation where the second control-plane message and the first information coupled with the downlink user-plane messages exist simultaneously in the same RE in the same time unit.

For example, there may be two cases. In one case, if the second control-plane message or the first information includes a section extension for indicating a priority of a section description, the one with the higher priority is used for controlling processing downlink user-plane messages. In the other case, if neither the second control-plane message nor the first information includes the section extension for indicating the priority of the section description, this is an undefined behavior. In this case, the O-RU is free to choose the second control-plane message or the first information for controlling processing downlink user-plane messages.

By the communication method of the present disclosure, by determining, for a periodic or semi-persistent channel or signal, that a trigger condition for a first control-plane message is satisfied; and transmitting a first control-plane message to an O-RAN radio unit (O-RU), the first control-plane message being used for indicating a first endpoint in the O-RU to perform an operation related to first information, the first information being used by the O-RU to periodically control receiving uplink air interface data or processing downlink user-plane messages, the periodic transmission of control-plane messages is avoided and the message load of the fronthaul interface is thus effectively reduced. Therefore, for channels or signals with periodic or semi-persistent characteristics, a defect that loads of the fronthaul interface could not be reduced by the existing solutions can be addressed.

According to the air interface data direction of the user-plane message controlled by the control-plane message, various embodiments of the present disclosure may be divided, for example, into two categories: an uplink embodiment, which is referred to as example 1; and a downlink embodiment, which is referred to as example 2. Here, the present disclosure will be described below by two examples.

Example 1: method for controlling uplink reception by a reusable control information set; and

Example 2: method for controlling downlink transmission by a reusable control information set.

The embodiments of the present disclosure are not limited to the above two embodiments, and any cases using or combining the innovations of the present disclosure shall fall into the scope of the present disclosure.

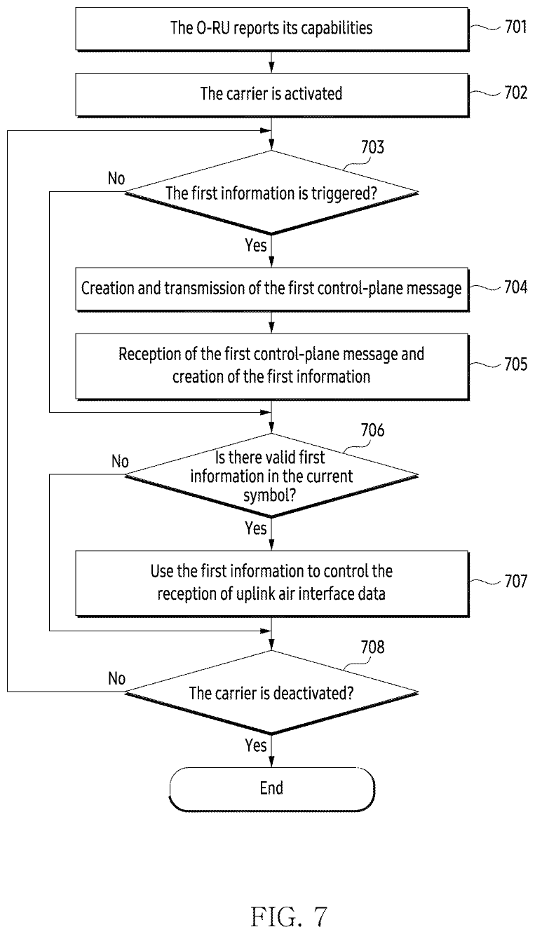

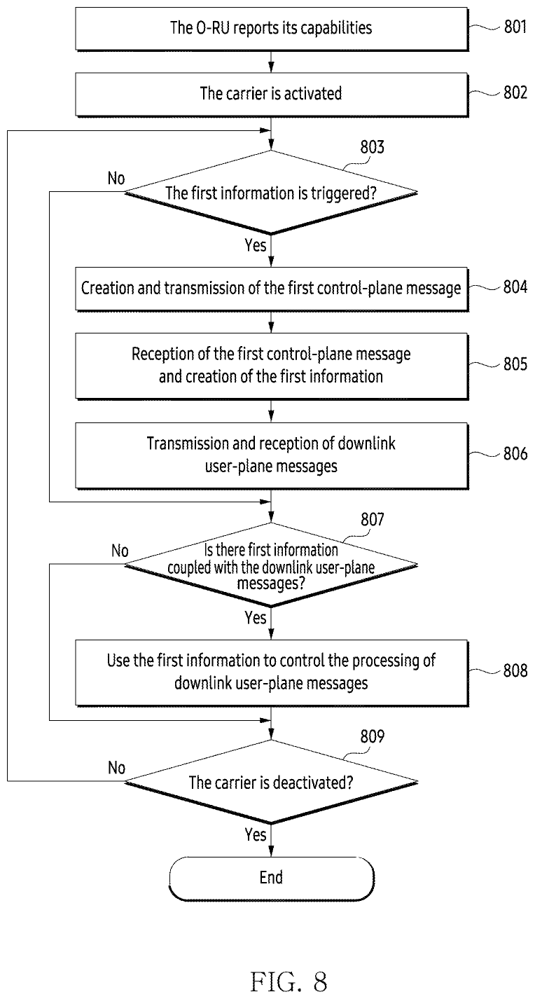

Taking the first information as “reusable control information set (RCIS)” as an example, the solutions of the above two embodiments will be described below in greater detail with reference to FIG. 7 and FIG. 8, respectively.

### EXAMPLE 1

FIG. 7, is a flowchart illustrating an example method for controlling uplink reception according to various embodiments.

In operation 701, the O-RU performs a capability reporting process to the O-DU, and the process is performed on the management planes of the O-RU and the O-DU. O-DU receives the capability information from the O-RU.

If some of the receiving endpoints of the O-RU have the first capability (the capability represents support for the reusable control information set section extension), it reports to the O-DU which endpoints have the first capability as “true”. In addition, each receiving endpoint that reports its first capability as “true” also needs to report the second capability (this capability indicates the maximum number of reusable control information sets that the receiving endpoint can support, which may be called max-reusable-control -info-sets).

This operation may further include other capability reporting, wherein the capabilities related to the present disclosure include the maximum number of sections supported by the receiving endpoint in one symbol (max-sections-per-symbol) and the maximum number of sections supported by the receiving endpoint in one slot (max-sections-per-slot).

Operation 702 is an uplink carrier activation process, and the subsequent steps 703 to 707 are performed repeatedly in each slot or each symbol in the state where the carrier is activated.

It should be noted that the uplink carrier activation process may be implemented by the existing related methods which, for the sake of brevity of description, may not be detailed here.

Operation 703 is a trigger process of the first control-plane message, which is performed in the O-DU application.

If an O-RU reports to the O-DU that some of its receiving endpoints have the first capability and satisfy the following capability conditions and trigger conditions, the O-DU may transmit a first control-plane message to the receiving endpoints of the O-RU whose first capability is “true” to setup, modify or delete first information.

For a given receiving endpoint, the O-DU may guarantee the following capability conditions:

A total number of the pieces of the first information in this endpoint does not exceed the second capability of this endpoint;

A sum of a number of section descriptions in a symbol and a number of pieces of the first information to be used in the symbol does not exceed the maximum number of sections supported by the receiving endpoint in one symbol; and

A sum of a number of section descriptions in a slot and a number of pieces of the first information to be used in the slot does not exceed the maximum number of sections supported by the receiving endpoint in one slot.

Further determination whether to trigger the first control-plane message at this endpoint may be made when the above conditions are satisfied.

The trigger condition for the first control-plane message may be as follows:

A setup of a periodic channel/signal or activation of a semi-persistent channel/signal: If the period of this periodic/semi-persistent channel/signal is less than 2560*Nₛₗₒₜ slots, the first control-plane message is triggered to cause the O-RU to create new first information, where Nₛₗₒₜ is the number of slots of the channel/signal in one subframe. And, if the signal is an SRS, and if the b-SRS is not configured as 0, the SRS has more than one sub-band. Then, the period here refers to the period of the SRS sub-band.

Modification of periodic/semi-persistent channel/signal resources, or update of receiving beams (for example, when the UE moves to the coverage of another receiving beam from the coverage of a receiving beam): If this periodic/semi-persistent channel/signal is associated with existing first information in the O-RU, the first control-plane message is triggered to cause the O-RU to modify the first information.

Release of periodic channel/signal or deactivation of semi-persistent channel/signal: if this periodic/semi-persistent channel/signal is associated with existing first information, and the first information is not associated with other periodic/semi-persistent channels/signals, the first control-plane message is triggered to cause the O-RU to delete the first information.

The periodic/semi-persistent channels/signals may be periodic/semi-persistent SRSs, PRACHs, or SPS PUSCHs.

Operation 704 is a first control-plane message creation and transmission process, which is performed in the O-DU application.

If the above conditions in operation 703 are satisfied, the O-DU creates a first control-plane message for each endpoint associated with the channel/signal, and transmits the first control-plane message to the O-RU. Different operation types (including SETUP, MODIFY and DELETE) need to be filled in the first control-plane message according to different trigger conditions in operation 703.

The first control-plane message contains a reusable control information set section extension (first information section extension) whose structure and definition may as shown in the following table:

TABLE 1

| | | | | | | | | |
|---|---|---|---|---|---|---|---|---|
| 0 | | | | | | | 7 | # of |
| (msb) | 1 | 2 | 3 | 4 | 5 | 6 | (lsb) | bytes |

| | | | |
|---|---|---|---|
| ef | extType | 1 | Octet N |

| extLen = 0 × 2 | | 1 | N + 1 |
|---|---|---|---|
| rcisOperation | Reserved | 1 | N + 2 |

| | | |
|---|---|---|
| rcisIndex | 2 | N + 3 |
| rcisPeriod | 2 | N + 5 |
| zero pad to 4-byte boundary | 1 | N + 7 |

The O-DU application needs to determine the fields in the first information section extension according to the trigger type and period of the first control-plane message:

RCIS operation option (rcisOperation): used for indicating the operation type for the first information, and different values indicate different operation types. For example, 0 represents “SETUP”, 1 represents “MODIFY”, and 2 represents “DELETE”.

RCIS index (rcisIndex): used for indicating to identify the first information in the receiving endpoint, and is the unique index of the first information in the receiving endpoint.

RCIS period (rcisPeriod): used for indicating the period at the boundary of which the first information is reused for user-plane message control, and the unit is slot. The O-RU needs to set this field to the period of the periodic/semi-persistent channel/signal. If the signal is an SRS, and if the b-SRS is not configured as 0, the period here refers to the period of the SRS sub-band.

It should be noted that if a control-plane message includes a plurality of first information section extensions, each first information section extension must use a different rcisIndex.

If this endpoint is configured to couple by sectionId, and certain first information is to be used in a certain slot, the O-DU shall not use the sectionId associated with this first information for the control-plane message in this slot, unless the control-plane message and the first message use different RE masks (reMasks) to schedule the same PRBs.

Operation 705 is a first control-plane message reception and first information creation process, which is performed in the O-RU application.

In a certain slot (frameId=n_{f}, subframeId=n_{sf}, slotId=nₛₗₒₜ), if the O-RU receives the first control-plane message from the O-DU, the first control-plane message belongs to an endpoint whose first capability is “true”, and the first control-plane message contains one or more control-plane messages, then the O-RU performs different operations according to the rcisOperation field in the first information of each control-plane message:

If rcisOperation indicates “SETUP”, the O-RU first searches in existing first information in this endpoint, and if first information whose rcisIndex is equal to the rcisIndex field in the first information is found, it ignores the first control-plane message, otherwise setups first information containing the following content in this endpoint:

RCIS index (rcisIndex): the unique index of the first information in the eAxCid, obtained from the rcisIndex field in the first information;

RCIS start slot (rcisStartSlot): the time when the first information starts to be used, which is obtained according to the frameId n_{f}, subframeId n_{sf}, slotId nₛₗₒ in the application common header of the control-plane message, and the number of slots Nₛₗₒₜ in one subframe. The Nₛₗₒₜ is obtained according to the frame structure information in the configuration of the management plane or in the application common header. The rcisStartSlot is calculated by (n_{f}*10+n_{sf})*Nₛₗₒₜ+nₛₗₒₜ, and the unit is slot.

It should be noted that the RCIS start slot may not be contained in the first information, and may be recalculated every time in the step 706 according to the rcisStartSlot calculation method.

RCIS period (rcisPeriod): the period at the boundary of which the first information is reused, obtained from the rcisPeriod field in the first information; at each period time when rcisStartSlot starts, the O-RU must process the first information, as if one control-plane message having the same control information is received, until the first information is modified or deleted.

RCIS section information (rcisSectionInfo): the information required to control the user-plane messages, obtained from the application common header in the first control-plane message and the control information in the section description carrying the first information.

In order to remove the dependency between the first information and other section descriptions, if the symInc field in the rcisSectionInfo is equal to 1, the O-RU modifies the startSymbolid field in the rcisSectionInfo to the actual start symbol identifier calculated according to the existing related methods, and then modifies the symInc field in rcisSectionInfo to 0.

If rcisOperation indicates “MODIFY”, the O-RU searches in existing first information in this endpoint to find first information whose rcisIndex is equal to the rcisIndex field in the first information, and then modifies the first information according to the application common header of the control-plane message and the section description carrying the first information.

If rcisOperation indicates “DELETE”, the O-RU searches in existing first information in this endpoint to find first information whose rcisIndex is equal to the rcisIndex field in the first information, and then removes it from existing first information in this endpoint.

If the first control-plane message contains a section extension Type 10, that is, an eAxCid is used to indicate the section description of a group of eAxCids, the first information will be applied to the endpoints corresponding to all eAxCids in the group.

Operation 706 is a process of judging whether there is first information available for the control of user-plane messages for a certain symbol, which is performed in the O-RU application.

For a certain symbol (frameId=n′_{f}, subframeId=n′_{sf}, slotId=n′ₛₗₒₜ, symbolId=n′_{sym}), for each uplink endpoint whose first capability is “true”, if there are several pieces of first information, and one or some of them satisfy the following conditions, it is considered that the first information will be used for the control of user-plane messages:

mod (curSlot−rcisStartSlot+MAX_SLOT_N, rcisPeriod)=0, and

n′_{sym} is equal to the symbol identifier obtained using rcisSectionInfo in the first information according to the existing related method.

where curSlot is the current slot identifier, which is equal to (n′_{f}*10+n′_{sf})*Nₛₗₒₜ+n′ₛₗₒₜ, and Nₛₗₒₜ is the number of slots in a subframe;

mod(x, y) represents the remainder obtained by dividing x by y;

rcisStartSlot and rcisPeriod are obtained from the first information; and

MAX_SLOT_N is equal to 2560*Nₛₗₒₜ.

If there is first information that satisfies the above conditions, the O-RU application transmits the first information to the Low-PHY.

If the second control-plane message and the first information that control the same RE of the same symbol exist simultaneously, if the second control-plane message or the first information contains section extensions Type 6, 12 or 19 and the priority of a section description is indicated in these section extensions, then the priority of the first information will be compared with the priority of the section description with the highest priority in the second control-plane message, and the one with the higher priority will be transmitted to the Low-PHY.

If neither the second control-plane message nor the first information contains section extensions Type 6, 12, or 19, it is an undefined behavior. In this case, the O-RU application is free to choose to transmit the second control-plane message or the first information to the Low-PHY.

Operation 707: The O-RU application uses the first information to control the Low-PHY to receive and process uplink air interface data. This operation is performed in the Low-PHY. The Low-PHY may use the rcisSectionInfo in the first information to control receiving uplink RF signals, according to the existing related methods.

After the O-RU completes the control of the reception and processing of the uplink RF signals by the first information, it transmits the corresponding I/Q data to the O-DU through one or more user-plane messages, wherein the application common header and the section header of the user-plane message are obtained according to the first information, and according to the frameId n′_{f}, subframeId n′_{sf}, slotId n′ₛₗₒₜ, and symbolId n′_{sym}.

In operation 708, O-DU or O-RU identify whether the carrier is deactivated or not. In case that the carrier is not deactivated, that is, the carrier is activated, O-DU performs the operation 703 again. In case that the carrier is activated, the procedure for the RCIS is terminated. In one embodiment, the carrier is associated with an extended antenna-carrier (eAxC). The eAxC indicates a data flow for a single antenna (or spatial stream) for a single carrier in a single sector. The eAxC includes the fields BandSector_ID, CC_ID, RU_Port_ID and DU_Port_ID.

### EXAMPLE 2

FIG. 8, is a flowchart illustrating an example method for controlling uplink reception according to various embodiments.

Operation 801 is similar to operation 701, with the difference that the endpoint in operation 801 should be a transmitting endpoint.

Operation 802 is similar to operation 702, with the difference that the carrier in the step 802 is a downlink carrier.

Operation 803 is similar to operation 703, with the difference that the endpoint in the step 803 should be a transmitting endpoint, and the periodic/semi-persistent channels/signals may be periodic/semi-persistent CSI-RSs, CRSs, or SPS PDSCHs.

Operation 804 is similar to operation 704.

Operation 805 is similar to operation 705.

Operation 806 is a process of transmitting and receiving downlink user-plane messages.

Operation 807 is to judge whether there is first information coupled with the downlink user-plane messages.

For each transmitting endpoint whose first capability is “true” and if the endpoint has first information, then, for each received downlink user-plane messages, the O-RU must try to couple it with the second control-plane message and the first information in this endpoint. The method for coupling the first information and the user-plane message is the same as or similar to the existing method for coupling the related control-plane message and the user-plane message, except that the following coupling conditions are different.

For section descriptions: information in the section description D in CM will be used for coupling, and “CM.frameId=UM.frameId, CM.subframeId=UM.subframeId, CM.slotId=UM.slotId”, where CM denotes control-plane messages and UM denotes user-plane messages. For example, for a second control-plane message, whether it is coupled with the downlink user-plane messages is determined according to the above coupling conditions.

For the coupling between the first information and the downlink user-plane messages, the above coupling conditions should be modified as follows:

information in rcisSectionInfo in the first information will be used for coupling, and mod (curSlot−rcisStartSlot+MAX_SLOT_N, rcisPeriod)=0;

where curSlot is the current slot identifier, which is equal to (UM.frameId*10+UM.subframeId)*Nₛₗₒₜ+UM. slotId, and Nₛₗₒₜ is the number of slots in a subframe;

mod(x, y) represents the remainder obtained by dividing x by y;

rcisStartSlot and rcisPeriod are obtained from the first information; and

MAX_SLOT_N is equal to 2560*Nₛₗₒₜ.

For the successfully coupled first information and user-plane message, the O-RU application transmits the first information and user-plane message to the Low-PHY.

If a second control-plane message and first information that are successfully coupled with the same RE of the same symbol of the user-plane message exist simultaneously, if the second control-plane message or the first information contains section extensions Type 6, 12 or 19, that is, the priority of a section description is indicated, the priority of the first information will be compared with the priority of the section description with the highest priority in the second control-plane message, and the one with high priority will be transmitted to the Low-PHY.

If neither the second control-plane message nor the first information contains section extensions Type 6, 12, or 19, it is an undefined behavior. In this case, the O-RU is free to choose to transmit the second control-plane message or the first information to the Low-PHY.

Operation 808 is a process of controlling transmitting downlink user-plane data by the first control-plane message, which is performed in the O-RU application and the Low-PHY. The Low-PHY uses the rcisSectionInfo in the first information to control transmitting downlink user-plane data, according to the existing related methods.

In operation 809, O-DU or O-RU identify whether the carrier is deactivated or not. In case that the carrier is not deactivated, that is, the carrier is activated, O-DU performs the operation 803 again. In case that the carrier is activated, the procedure for the RCIS is terminated. In one embodiment, the carrier is associated with an extended antenna-carrier (eAxC). The eAxC indicates a data flow for a single antenna (or spatial stream) for a single carrier in a single sector. The eAxC includes the fields BandSector_ID, CC_ID, RU_Port_ID and DU_Port_ID.

Based on the same principles as the methods provided in the above-mentioned embodiments of the present disclosure, the present disclosure also provides a communication apparatus for an open radio access network (O-RAN), which is applied to an O-RAN distributed unit (O-DU), including:

A determination module for determining, for a periodic or semi-persistent channel or signal, that a trigger condition for a first control-plane message is satisfied; and

A transmitting module for transmitting a first control-plane message to an O-RAN radio unit (O-RU), the first control-plane message being used for indicating a first endpoint in the O-RU to perform an operation related to first information, the first information being used by the O-RU to periodically control receiving uplink air interface data or processing downlink user-plane messages.

In various embodiments, the apparatus may further include:

A receiving module for receiving information related to second endpoints, which is reported by the O-RU, the information related to the second endpoints including a first capability and a second capability possessed by the second endpoints, wherein the first capability indicates that the second endpoints support a first information section extension, and the second capability indicates a maximum value of a number of pieces of the first information supported by the second endpoints; and

The determination module is further used for determining, according to the information related to the second endpoints, the first endpoint from the second endpoints.

In various embodiments, the first endpoint is an endpoint that satisfies a first condition, and the first condition includes at least one of the following:

A total number of the pieces of the first information corresponding to the first endpoint does not exceed a maximum value indicated by the second capability of the first endpoint; and

A sum of a number of section descriptions that do not contain the first information section extension in one time unit and a number of pieces of the first information to be used in the one time unit does not exceed a maximum value of the number of section descriptions supported by the first endpoint in the one time unit.

In various embodiments, the determination module may be used for determining, according to information related to a periodic or semi-persistent channel or signal, that a trigger condition for a first control-plane message is satisfied.

In various embodiments, the apparatus further includes a creation module, wherein:

The determination module is further used for determining, according to the trigger condition, a type of the operation related to the first information; and

The creation module is used for creating a first control-plane message, according to the type of the operation related to the first information and a period of the periodic or semi-persistent channel or signal.

In various embodiments, the first control-plane message includes a first information section extension, and the creation module is specifically used for determining a first information operation field, a first information index field and a first information period field in the first information section extension, according to the type of the operation related to the first information and the period of the periodic or semi-persistent channel or signal.

In various embodiments, if the first control-plane message includes a plurality of first information section extensions, each first information section extension uses a different first information identifier.

In various embodiments, if the first endpoint is configured to be coupled by a section identifier, and when the first information is to be used in a current time unit, and a second control-plane message and the first information do not use different resource element (RE) masks to schedule the same physical resource blocks (PRBs), then a section identifier associated with the first information is not used for the second control-plane message in the current time unit.

In various embodiments, the first control-plane message further includes: a section extension for indicating a section description of a group of extended antenna-carrier identifiers; and/or a section extension for indicating a priority of a section description.

In various embodiments, if the first endpoint is a receiving endpoint, the periodic or semi-persistent channel or signal is a physical random access channel (PRACH), or a semi-persistent scheduling physical uplink shared channel (SPS PUSCH), or a periodic or semi-persistent uplink sounding reference signal (SRS); and

If the first endpoint is a transmitting endpoint, the periodic or semi-persistent channel or signal is a semi-persistent scheduling physical downlink shared channel (SPS PDSCH), or a cell reference signal (CRS), or a periodic or semi-persistent channel status information reference signal (CSI-RS).

Based on the same principles as the methods provided in the above-mentioned embodiments of the present disclosure, the present disclosure also provides a communication apparatus for an open radio access network (O-RAN), which is applied to an O-RAN radio unit (O-RU), including:

A receiving module for receiving a first control-plane message from an O-DU, the first control-plane message being used for indicating a first endpoint in the O-RU to perform an operation related to first information; and

A processing module for performing the operation related to the first information in a first endpoint, according to the first control-plane message, wherein the first information is used by the O-RU to periodically control receiving uplink air interface data or processing downlink user-plane messages.

In various embodiments, the apparatus further includes a transmitting module configured to report information related to second endpoints to an O-DU, the information related to second endpoints being used by the O-DU to determine the first endpoint. The information related to second endpoints includes a first capability and a second capability possessed by the second endpoints, wherein the first capability indicates that the second endpoints support a first information section extension, and the second capability indicates a maximum value of a number of pieces of the first information supported by the second endpoints.

In various embodiments, the processing module is specifically configured to determine a type of the operation related to the first information, according to the first control-plane message; and perform the operation related to the first information in the first endpoint, according to the type of the operation related to the first information.

In various embodiments, the first control-plane message includes a first information section extension, and when determining a type of the operation related to the first information according to the first control-plane message, the processing module is specifically configured to determine the type of the operation related to the first information, according to a first information operation field in the first information section extension of the first control-plane message.

In various embodiments, when performing the operation related to the first information in the first endpoint according to the type of the operation related to the first information, the processing module is specifically configured to:

if the operation related to the first information is to setup the first information, and if no first information having a first information identifier equal to a first information identifier field in a first information section extension has been found in existing first information in the first endpoint, setup first information including a first information identifier, a first information period, and first information section information, in the first endpoint;

if the operation related to the first information is to modify the first information, search first information having a first information identifier equal to the first information identifier field in the first information section extension from existing first information in the first endpoint, and modify the found first information according to an application common header of the first control-plane message and a section description containing the first information section extension; and

if the operation related to the first information is to delete the first information, search first information having a first information identifier equal to the first information identifier field in the first information section extension from existing first information in the first endpoint, and delete the found first information from existing first information in the first endpoint.

In various embodiments, if the first control-plane message further includes a section extension for indicating a group of extended antenna-carrier identifiers, the processing module is specifically configured to perform the operation related to the first information in endpoints corresponding to the group of extended antenna-carrier identifiers, according to the first control-plane message.

In various embodiments, if the first endpoint is a receiving endpoint, the processing module is specifically configured to, for a given time unit, determine that one or more pieces of first information satisfying a second condition will be used for controlling receiving uplink air interface data, wherein the given time unit is a time unit in which the first control-plane message is received, or a time unit behind the time unit in which the first control-plane message is received.

In various embodiments, if the second control-plane message and the first information that control the same resource element (RE) of the given time unit exist simultaneously, the processing module is specifically configured to:

if the second control-plane message or the first information includes a section extension for indicating a priority of a section description, determine one with a higher priority from the first information and a first section description, and use the one with the higher priority to the control receiving uplink air interface data, wherein the first section description is a section description with the highest priority in the second control-plane message; and

if neither the second control-plane message nor the first information includes the section extension for indicating the priority of the section description, determine that the second control-plane message or the first information will be used for controlling receiving uplink air interface data.

In various embodiments, the transmitting module is further configured to, if the determined first information is used for controlling receiving uplink air interface data, transmit the corresponding data to the O-DU through one or more uplink user-plane messages, wherein the application common header and the section header of the uplink user-plane messages are obtained based on the first information and information related to the given time unit.

In various embodiments, if the first endpoint is a transmitting endpoint, the processing module is further configured to:

in various embodiments, if the transmitting endpoint has corresponding first information, for the received downlink user-plane messages, determine first information coupled with the downlink user-plane messages; and

control processing downlink user-plane messages by using the first information coupled with the downlink user-plane messages.

In various embodiments, if the second control-plane message and the first information coupled with the downlink user-plane messages exist simultaneously in the same RE in the same time unit, the processing module is further configured to:

if the second control-plane message or the first information includes a section extension for indicating a priority of a section description, determine one with a higher priority from the first information and a second section description, and use the one with the higher priority to control processing downlink user-plane messages, wherein the second section description is a section description with the highest priority in the second control-plane message; and

if neither the second control-plane message nor the first information includes the section extension for indicating the priority of the section description, determine that the second control-plane message or the first information will be used for controlling processing downlink user-plane messages.

According to various embodiments, a method performed by an open radio access network (O-RAN) distributed unit (O-DU), the method comprises, for a periodic or semi-persistent signaling, determining that a trigger condition for a first control-plane message is satisfied; and transmitting the first control-plane message to an O-RAN radio unit (O-RU), the first control-plane message indicating a first endpoint in the O-RU and being associated with first information. The first information is used to periodically control to receive uplink air interface data or process downlink user-plane messages in the O-RU.

In some embodiments, before transmitting the first control-plane message to the O-RU, the method further comprises receiving information related to second endpoints reported by the O-RU, the information related to the second endpoints including a first capability and a second capability possessed by the second endpoints, wherein the first capability indicates that the second endpoints support a first information section extension, and the second capability indicates a maximum value of a number of pieces of the first information supported by the second endpoints; and determining, based on the information related to the second endpoints, the first endpoint from the second endpoints.

In some embodiments, wherein the first endpoint includes an endpoint satisfying a first condition. The first condition includes at least one of a total number of the pieces of the first information corresponding to the first endpoint does not exceed a maximum value indicated by the second capability of the first endpoint; or a sum of a number of section descriptions that do not contain the first information section extension in one time unit and a number of pieces of the first information to be used in the one time unit does not exceed a maximum value of the number of section descriptions supported by the first endpoint in the one time unit.

In some embodiments, the method further comprises determining, based on the trigger condition, a type of an operation related to the first information; and creating the first control-plane message, based on the type of the operation related to the first information and a period of the periodic or semi-persistent signaling. The first control-plane message includes a first information section extension. The creating of the first control-plane message, comprises determining a first information operation field, a first information identifier field, and a first information period field in the first information section extension, based on the type of the operation related to the first information and the period of the periodic or semi-persistent signaling.

In some embodiments, if the first control-plane message includes a plurality of first information section extensions, each of the plurality first information section extension uses a different first information identifier.

In some embodiments, if the first endpoint is configured to be coupled by a section identifier, and if the first information is to be used in a current time unit, and a second control-plane message and the first information do not use different resource element (RE) masks to schedule the same physical resource blocks (PRBs), a section identifier associated with the first information is not used for the second control-plane message in the current time unit.

In some embodiments, the first control-plane message includes at least one of a section extension indicating a section description of a group of extended antenna-carrier identifiers, or a section extension indicating a priority of the section description.

According to various embodiments, a method performed by an open radio access network (O-RAN) radio unit (O-RU), the method comprises receiving a first control-plane message from an O-DU, the first control-plane message indicating a first endpoint in the O-RU and being associated with first information, and performing an operation related to the first information in the first endpoint, based on the first control-plane message. The first control-plane message is associated with a periodic or semi-persistent signaling. The first information is used to periodically control to receive uplink air interface data or process downlink user-plane messages in the O-RU.

In some embodiments, before receiving the first control-plane message from the O-DU, the method further comprises reporting information related to second endpoints to an O-DU, the information related to the second endpoints being used to determine the first endpoint. The information related to the second endpoints includes a first capability and a second capability possessed by the second endpoints. The first capability indicates that the second endpoints support a first information section extension, and the second capability indicates a maximum value of a number of pieces of the first information supported by the second endpoints.

In some embodiments, the performing of the operation related to the first information in the first endpoint, based on the first control-plane message, comprises: determining a type of the operation related to the first information, based on the first control-plane message; and performing the operation related to the first information in the first endpoint, based on the type of the operation related to the first information. The first control-plane message includes the first information section extension. The type of the operation related to the first information is determined based on a first information operation field in the first information section extension of the first control-plane message.

In some embodiments, the performing of the operation related to the first information in the first endpoint, based on the type of the operation related to the first information, comprises: if the operation related to the first information is to setup the first information, and if no first information having a first information identifier equal to a first information identifier field in a first information section extension has been found in existing first information in the first endpoint, setting up first information including a first information identifier, a first information period, and first information section information, in the first endpoint; if the operation related to the first information is to modify the first information, searching the first information having the first information identifier equal to the first information identifier field in the first information section extension from existing first information in the first endpoint, and modifying the found first information based on an application common header of the first control-plane message and a section description containing the first information section extension; and if the operation related to the first information is to delete the first information, searching the first information having the first information identifier equal to the first information identifier field in the first information section extension from existing first information in the first endpoint, and deleting the found first information from existing first information in the first endpoint.

In some embodiments, if the first control-plane message further includes a section extension for indicating a group of extended antenna-carrier identifiers, the performing of the operation related to the first information in the first endpoint, based on the first control-plane message, comprises: performing the operation related to the first information in endpoints corresponding to the group of extended antenna-carrier identifiers, based on the first control-plane message.

In some embodiments, the performing of the operation related to the first information comprises, for the received downlink user-plane messages, determining that the first information is coupled with the downlink user-plane messages; and using the first information to control processing the downlink user-plane messages.

In some embodiments, the method further comprises if a second control-plane message or the first information includes a section extension for indicating a priority of a section description, determining one of the first information and a second section description based on a higher priority, and processing downlink user-plane messages by using the one of the first information and the second section description, wherein the second section description is a section description with the highest priority in the second control-plane message; and if neither the second control-plane message nor the first information includes the section extension for indicating the priority of the section description, determining that the second control-plane message or the first information will be used for controlling processing downlink user-plane messages.

According to various embodiments, an apparatus of an open radio access network (O-RAN) distributed unit (O-DU), comprises at least one transceiver; and at least one processor operably coupled to the at least one transceiver. The at least one processor is configured to, for a periodic or semi-persistent signaling, determine that a trigger condition for a first control-plane message is satisfied; and transmit the first control-plane message to an O-RAN radio unit (O-RU), the first control-plane message indicating a first endpoint in the O-RU and being associated with first information. The first information is used to periodically control to receive uplink air interface data or process downlink user-plane messages in the O-RU.

In some embodiments, before transmitting the first control-plane message to the O-RU, wherein the at least one processor is further configured to receive information related to second endpoints reported by the O-RU, the information related to the second endpoints including a first capability and a second capability possessed by the second endpoints, wherein the first capability indicates that the second endpoints support a first information section extension, and the second capability indicates a maximum value of a number of pieces of the first information supported by the second endpoints, and determine, based on the information related to the second endpoints, the first endpoint from the second endpoints.

In some embodiments, the first endpoint includes an endpoint satisfying a first condition. The first condition includes at least one of a total number of the pieces of the first information corresponding to the first endpoint does not exceed a maximum value indicated by the second capability of the first endpoint, or a sum of a number of section descriptions that do not contain the first information section extension in one time unit and a number of pieces of the first information to be used in the one time unit does not exceed a maximum value of the number of section descriptions supported by the first endpoint in the one time unit.

In some embodiments, the at least one processor is further configured to determine, based on the trigger condition, a type of an operation related to the first information; and create the first control-plane message, based on the type of the operation related to the first information and a period of the periodic or semi-persistent signaling. The first control-plane message includes a first information section extension. The at least one processor is configured to create the first control-plane message by determining a first information operation field, a first information identifier field, and a first information period field in the first information section extension, based on the type of the operation related to the first information and the period of the periodic or semi-persistent signaling.

In some embodiments, if the first control-plane message includes a plurality of first information section extensions, each of the plurality first information section extension uses a different first information identifier.

In some embodiments, if the first endpoint is configured to be coupled by a section identifier, and if the first information is to be used in a current time unit, and a second control-plane message and the first information do not use different resource element (RE) masks to schedule the same physical resource blocks (PRBs), a section identifier associated with the first information is not used for the second control-plane message in the current time unit.

According to various embodiments, an apparatus of an open radio access network (O-RAN) radio unit (O-RU), comprises at least one transceiver; and at least one processor operably coupled to the at least one transceiver. The at least one processor is configured to, receive a first control-plane message from an O-DU, the first control-plane message indicating a first endpoint in the O-RU and being associated with first information; and perform an operation related to the first information in the first endpoint, based on the first control-plane message. The first control-plane message is associated with a periodic or semi-persistent signaling. The first information is used to periodically control to receive uplink air interface data or process downlink user-plane messages in the O-RU.

In some embodiments, before receiving the first control-plane message from the O-DU, the at least one processor is further configured to report information related to second endpoints to an O-DU, the information related to the second endpoints being used to determine the first endpoint. The information related to the second endpoints includes a first capability and a second capability possessed by the second endpoints. The first capability indicates that the second endpoints support a first information section extension, and the second capability indicates a maximum value of a number of pieces of the first information supported by the second endpoints.

In some embodiments, to perform the operation related to the first information in the first endpoint, based on the first control-plane message, the at least one processor is configured to determine a type of the operation related to the first information, based on the first control-plane message; and perform the operation related to the first information in the first endpoint, based on the type of the operation related to the first information. The first control-plane message includes the first information section extension. The type of the operation related to the first information is determined based on a first information operation field in the first information section extension of the first control-plane message.

In some embodiments, to perform the operation related to the first information in the first endpoint, based on the first control-plane message, the at least one processor is configured to, if the operation related to the first information is to setup the first information, and if no first information having a first information identifier equal to a first information identifier field in a first information section extension has been found in existing first information in the first endpoint, set up first information including a first information identifier, a first information period, and first information section information, in the first endpoint; if the operation related to the first information is to modify the first information, searching the first information having the first information identifier equal to the first information identifier field in the first information section extension from existing first information in the first endpoint, and modify the found first information based on an application common header of the first control-plane message and a section description containing the first information section extension; and if the operation related to the first information is to delete the first information, searching the first information having the first information identifier equal to the first information identifier field in the first information section extension from existing first information in the first endpoint, and delete the found first information from existing first information in the first endpoint.

In some embodiments, if the first control-plane message further includes a section extension for indicating a group of extended antenna-carrier identifiers, to perform the operation related to the first information in the first endpoint, based on the first control-plane message, the at least one processor is configured to perform the operation related to the first information in endpoints corresponding to the group of extended antenna-carrier identifiers, based on the first control-plane message.

In some embodiments, to perform the operation related to the first information in the first endpoint, based on the first control-plane message, the at least one processor is configured to, for the received downlink user-plane messages, determine that the first information is coupled with the downlink user-plane messages; and use the first information to control processing the downlink user-plane messages.

In some embodiments, the at least one processor is further configured to, if a second control-plane message or the first information includes a section extension for indicating a priority of a section description, determine one of the first information and a second section description based on a higher priority, and process downlink user-plane messages by using the one of the first information and the second section description, wherein the second section description is a section description with the highest priority in the second control-plane message; and if neither the second control-plane message nor the first information includes the section extension for indicating the priority of the section description, determine that the second control-plane message or the first information will be used for controlling processing downlink user-plane messages.

Based on the same principles as the methods provided in the above-mentioned embodiments of the present application, an embodiment of the present application provides an electronic device, including a memory and a processor; and at least one program that, stored in the memory, can implement the method provided in any optional embodiment of the present application.

The electronic device may include an O-RAN distributed unit (O-DU), and the processor may, when running the computer program, execute operations corresponding to the communication method performed by the O-DU in any optional embodiment of the present application.

The electronic device may include an O-RAN radio unit (O-RU), and the processor may, when running the computer programs, execute operations corresponding to the communication method performed by the O-RU in any optional embodiment of the present application.

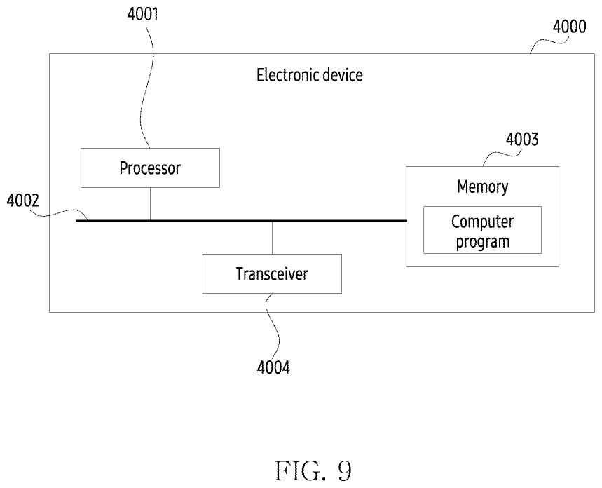

FIG. 9 is a block diagram illustrating an example configuration of an electronic device according to various embodiments. As shown in FIG. 9, the electronic device 4000 shown in FIG. 9 includes a processor (e.g., including processing circuitry) 4001 and a memory 4003. The processor 4001 is connected to the memory 4003, for example, through a bus 4002. The electronic device 4000 may further include a transceiver 4004, and the transceiver 4004 may be used for data interaction between the electronic device and other electronic devices, for example, data transmission and/or data reception. It should be noted that, in practical applications, the transceiver 4004 is not limited to one, and the structure of the electronic device 4000 does not constitute any limitations to the embodiments of the present disclosure.

The processor 4001 may include various processing circuitry, such as, for example, and without limitation, central processing units (CPUs), general-purpose processors, digital signal processors (DSPs), application specific integrated circuits (ASICs), or field programmable gate arrays (FPGAs), or other programmable logic devices, transistor logic devices, hardware components, or any combinations thereof. It may implement or execute various example logical blocks, modules and circuits described in connection with the present disclosure. The processor 4001 may also be a combination for realizing computing functions, for example, a combination of one or more microprocessors, a combination of a DSP and a microprocessor, etc.

The bus 4002 may include a path to transfer information between the components described above. The bus 4002 may be peripheral component interconnect (PCI) buses, extended industry standard architecture (EISA) buses, etc. The bus 4002 may be address buses, data buses, control buses, etc. For ease of presentation, the bus is represented by only one thick line in FIG. 9. However, it does not refer, for example, to there being only one bus or one type of buses.

The memory 4003 may be, but not limited to, read only memories (ROMs) or other types of static storage devices that can store static information and instructions, random access memories (RAMs) or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, blu-ray discs, etc.), magnetic storage media or other magnetic storage devices, or any other media that can carry or store desired program codes in the form of instructions or data structures and that can be accessed by computers.

The memory 4003 may be used to store application program codes (computer programs) for executing the solutions of the present application, and is controlled by the processor 4001. The processor 4001 is used to execute the application program codes stored in the memory 4003 to implement the content shown in the foregoing method embodiments.

In the present disclosure, the term ‘O-DU’ may be replaced with the term ‘DU’. Also, the term ‘O-RU’ may be replaced with the term ‘RU’. In other words, the replacement is not used to limit the embodiments or operations disclosed herein.

It should be understood that although the operations illustrated in the drawings are sequentially displayed by following the arrows, these operations are not necessarily performed in the order indicated by the arrows. Unless explicitly stated herein, the execution order of these operations is not strictly limited, and they can be performed in other orders. Moreover, at least some of the operations in the flowcharts shown in the drawings may include a plurality of sub-operations or a plurality of stages. These sub-operations or stages are not necessarily performed at the same moment of time, and instead, may be performed at different moments of time. The sub-operations or stages are not necessarily performed sequentially, and instead, may be performed in turn or alternately with other operations or at least some of the sub-steps or stages of other steps.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method performed by an open radio access network (O-RAN) distributed unit (O-DU), the method comprising:
for a periodic or semi-persistent signaling, determining that a trigger condition for a first control-plane message is satisfied; and
transmitting the first control-plane message to an O-RAN radio unit (O-RU), the first control-plane message indicating a first endpoint in the O-RU and being associated with first information,
wherein the first information is used to periodically control to receive uplink air interface data or process downlink user-plane messages in the O-RU.

2. The method according to claim 1, wherein, before transmitting the first control-plane message to the O-RU, the method further comprising:
receiving information related to second endpoints reported by the O-RU, the information related to the second endpoints including a first capability and a second capability possessed by the second endpoints, wherein the first capability indicates that the second endpoints support a first information section extension, and the second capability indicates a maximum value of a number of pieces of the first information supported by the second endpoints; and
determining, based on the information related to the second endpoints, the first endpoint from the second endpoints.

3. The method according to claim 2,
wherein the first endpoint includes an endpoint satisfying a first condition, and
wherein the first condition includes at least one of:
a total number of the pieces of the first information corresponding to the first endpoint does not exceed a maximum value indicated by the second capability of the first endpoint; or
a sum of a number of section descriptions that do not contain the first information section extension in one time unit and a number of pieces of the first information to be used in the one time unit does not exceed a maximum value of the number of section descriptions supported by the first endpoint in the one time unit.

4. The method according to claim 1, the method further comprising:
determining, based on the trigger condition, a type of an operation related to the first information; and
creating the first control-plane message, based on the type of the operation related to the first information and a period of the periodic or semi-persistent signaling,
wherein the first control-plane message includes a first information section extension, and,
wherein the creating of the first control-plane message, comprises:
determining a first information operation field, a first information identifier field, and a first information period field in the first information section extension, based on the type of the operation related to the first information and the period of the periodic or semi-persistent signaling.

5. The method according to claim 4, wherein, if the first control-plane message includes a plurality of first information section extensions, each of the plurality first information section extension uses a different first information identifier.

6. The method according to claim 1, wherein, if the first endpoint is configured to be coupled by a section identifier, and if the first information is to be used in a current time unit, and a second control-plane message and the first information do not use different resource element (RE) masks to schedule the same physical resource blocks (PRBs), a section identifier associated with the first information is not used for the second control-plane message in the current time unit.

7. The method according to claim 1, wherein the first control-plane message includes at least one of:
a section extension indicating a section description of a group of extended antenna-carrier identifiers, or
a section extension indicating a priority of the section description.

8. A method performed by an open radio access network (O-RAN) radio unit (O-RU), the method comprising:
receiving a first control-plane message from an O-DU, the first control-plane message indicating a first endpoint in the O-RU and being associated with first information; and
performing an operation related to the first information in the first endpoint, based on the first control-plane message,
wherein the first control-plane message is associated with a periodic or semi-persistent signaling, and
wherein the first information is used to periodically control to receive uplink air interface data or process downlink user-plane messages in the O-RU.

9. The method according to claim 8, before receiving the first control-plane message from the O-DU, the method further comprising:
reporting information related to second endpoints to an O-DU, the information related to the second endpoints being used to determine the first endpoint,
wherein the information related to the second endpoints includes a first capability and a second capability possessed by the second endpoints, and
wherein the first capability indicates that the second endpoints support a first information section extension, and the second capability indicates a maximum value of a number of pieces of the first information supported by the second endpoints.

10. The method according to claim 9, wherein the performing of the operation related to the first information in the first endpoint, based on the first control-plane message, comprises:
determining a type of the operation related to the first information, based on the first control-plane message; and
performing the operation related to the first information in the first endpoint, based on the type of the operation related to the first information,
wherein the first control-plane message includes the first information section extension, and
wherein the type of the operation related to the first information is determined based on a first information operation field in the first information section extension of the first control-plane message.

11. The method according to claim 9, wherein the performing of the operation related to the first information in the first endpoint, based on the type of the operation related to the first information, comprises:
if the operation related to the first information is to setup the first information, and if no first information having a first information identifier equal to a first information identifier field in a first information section extension has been found in existing first information in the first endpoint, setting up first information including a first information identifier, a first information period, and first information section information, in the first endpoint;
if the operation related to the first information is to modify the first information, searching the first information having the first information identifier equal to the first information identifier field in the first information section extension from existing first information in the first endpoint, and modifying the found first information based on an application common header of the first control-plane message and a section description containing the first information section extension; and
if the operation related to the first information is to delete the first information, searching the first information having the first information identifier equal to the first information identifier field in the first information section extension from existing first information in the first endpoint, and deleting the found first information from existing first information in the first endpoint.

12. The method according to claim 9, wherein, if the first control-plane message further includes a section extension for indicating a group of extended antenna-carrier identifiers, the performing of the operation related to the first information in the first endpoint, based on the first control-plane message, comprises:
performing the operation related to the first information in endpoints corresponding to the group of extended antenna-carrier identifiers, based on the first control-plane message.

13. The method according to claim 9, wherein the performing of the operation related to the first information comprises:
for the received downlink user-plane messages, determining that the first information is coupled with the downlink user-plane messages; and
using the first information to control processing the downlink user-plane messages.

14. The method according to claim 13, wherein, the method further comprises:
if a second control-plane message or the first information includes a section extension for indicating a priority of a section description, determining one of the first information and a second section description based on a higher priority, and processing downlink user-plane messages by using the one of the first information and the second section description, wherein the second section description is a section description with the highest priority in the second control-plane message; and
if neither the second control-plane message nor the first information includes the section extension for indicating the priority of the section description, determining that the second control-plane message or the first information will be used for controlling processing downlink user-plane messages.

15. An apparatus of an open radio access network (O-RAN) distributed unit (O-DU), comprising:
at least one transceiver; and
at least one processor operably coupled to the at least one transceiver, configured to:
for a periodic or semi-persistent signaling, determine that a trigger condition for a first control-plane message is satisfied, and
transmit the first control-plane message to an O-RAN radio unit (O-RU), the first control-plane message indicating a first endpoint in the O-RU and being associated with first information,
wherein the first information is used to periodically control to receive uplink air interface data or process downlink user-plane messages in the O-RU.

16. The apparatus of claim 15, before transmitting the first control-plane message to the O-RU, wherein the at least one processor is further configured to:
receive information related to second endpoints reported by the O-RU, the information related to the second endpoints including a first capability and a second capability possessed by the second endpoints, wherein the first capability indicates that the second endpoints support a first information section extension, and the second capability indicates a maximum value of a number of pieces of the first information supported by the second endpoints, and
determine, based on the information related to the second endpoints, the first endpoint from the second endpoints.

17. The apparatus of claim 16,
wherein the first endpoint includes an endpoint satisfying a first condition, and
wherein the first condition includes at least one of:
a total number of the pieces of the first information corresponding to the first endpoint does not exceed a maximum value indicated by the second capability of the first endpoint, or
a sum of a number of section descriptions that do not contain the first information section extension in one time unit and a number of pieces of the first information to be used in the one time unit does not exceed a maximum value of the number of section descriptions supported by the first endpoint in the one time unit.

18. The apparatus of claim 15, wherein the at least one processor is further configured to:
determine, based on the trigger condition, a type of an operation related to the first information; and
create the first control-plane message, based on the type of the operation related to the first information and a period of the periodic or semi-persistent signaling,
wherein the first control-plane message includes a first information section extension, and
wherein the at least one processor is configured to create the first control-plane message by determining a first information operation field, a first information identifier field, and a first information period field in the first information section extension, based on the type of the operation related to the first information and the period of the periodic or semi-persistent signaling.

19. The apparatus of claim 18, wherein, if the first control-plane message includes a plurality of first information section extensions, each of the plurality first information section extension uses a different first information identifier.

20. The apparatus of claim 15, wherein, if the first endpoint is configured to be coupled by a section identifier, and if the first information is to be used in a current time unit, and a second control-plane message and the first information do not use different resource element (RE) masks to schedule the same physical resource blocks (PRBs), a section identifier associated with the first information is not used for the second control-plane message in the current time unit.
